(19) United States
(12) Patent Application Publication
(10) Pub. No.: US 2023/0141105 A1
(43) Pub. Date: May 11, 2023

(54) METHOD OF MAKING A FROZEN CREAM PRODUCT CONTAINING ALCOHOL

(71) Applicant: John-Michael Hamlet, Charlottesville, VA (US)

(72) Inventor: John-Michael Hamlet, Charlottesville, VA (US)

(21) Appl. No.: 17/520,903

(22) Filed: Nov. 8, 2021

(51) Int. Cl. A23G 9/42; A23G 9/04; A23G 9/34; A23G 9/40

(52) U.S. Cl. CPC A23G 9/42; A23G 9/04; A23G 9/34; A23G 9/40; A23V 2002/00

(57) ABSTRACT

A method of making a frozen cream product containing a range between 0-15% alcoholic beverage by volume without using any additives, preservatives, unnatural stabilizers and unnatural emulsifiers such that a combined cream product containing the alcoholic beverage will not undergo alcohol-water separation during the processes of making the combined cream product containing alcohol or during the process of freezing the combined cream product containing alcohol to form the frozen cream product containing alcohol.

### STATEMENT REGARDING FEDERALLY SPONSORED RESEARCH OR DEVELOPMENT

Not applicable.

### COPYRIGHT NOTICE

A portion of this disclosure contains material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever. 37 C.F.R 1.71(d).

### BACKGROUND OF THE INVENTIVE CONCEPT

### 1. Field of the Invention

The present inventive concept relates to a method of making a frozen cream product with alcohol contained therein and a resulting alcohol infused frozen cream product. More particularly, but not exclusively, this inventive concept relates to a process of making an organic, non-additive and non-preservative frozen cream product with alcohol contained therein by a unique way such that the infused alcohol does not dissipation or evaporate or separate from the frozen cream product during the process of making the alcohol infused frozen cream product or during the process of freezing the completed frozen cream product containing alcohol, and a resulting frozen cream product containing alcohol.

### Description of the Related Art

Ice creams, gelatos, sorbets, custards and other frozen dessert products have been manufactured for centuries, with countless ways of making each of them. However, most of these frozen products are manufactured with additives and preservatives, and very few have been successfully made with alcohol infused therein. Conventional attempts at making an ice cream product with alcohol have required several types of unnatural stabilizers, emulsifiers, and other binding and gelling agents, as well as other non-organic ingredients, and still result in a product with icy crystals and separated alcohol from the dairy portions thereof.

U.S. 2009/0311405 A1 by Marasso describes an ice cream type confectionary product and preparation process that includes an ethyl alcohol content of 0.5% to 3% volume/weight. However, this product is sold as a liquid, not a frozen solid, and requires emulsion stabilizing additives, flavorings, water and emulsifiers. This document states that “[i]t is preferable to use sucrose and/or fructose as a sweetener, optionally in combination with glucose syrup, maltodextrin and sorbitol syrup. The use of fructose is advantageous, because it reduces the freezing point of the emulsion oven to its low molecular weight.” This process also states that the emulsion “according to the invention also comprises additives for thickening and stabilizing the emulsion, preferably including a stabilizing protein salt and one or more hydrocolloids.” Accordingly, this product cannot be categorized as either an alcohol infused frozen cream product or an organic product, or a product without additives or preservatives.

U.S. 2001/0041208 A1 by Orris et al. describes a stabilization process for adding ethyl alcohol to ice cream. Here a stabilizing component is provided into an ice cream mix. The stabilizing component includes “non-thermoreversible gums such as mannan gums, e.g., locus bean gum, digestible thickening gums (such as cellulosic gum and lower molecular weight and digestible or inert natural or synthetic resins, extenders and gums) and thermoreversible gums such as carrageenan . . . whereby when said stabilizing ice cream mix blend is combined with a basic ice cream mix and subsequently with ethyl alcohol and then frozen, the ethyl alcohol molecule is stabilized in an ice cream like product so that after freezing, the ethyl alcohol does not change form, texture or homogeneity of the ice cream like product in an adverse manner.” In other words, Orris et al. relies on an extensive amount of stabilizing additives/preservatives in order to have alcohol remain stable in the ice cream.

U.S. Pat. No.: 10,716,318 by Melvin is directed to an alcohol containing bulk frozen dessert product that consists essentially of a homogeneous blend of pasteurized bulk frozen dessert product mix, an alcohol containing composition, at least one sugar substitute and several other unnatural ingredients. More specifically, this frozen dessert product requires the addition of stabilizers and emulsifiers in both the alcohol containing composition and in the bulk frozen dessert product mix. As pointed out in this patent, “the stabilizer used in the . . . invention may include, but is not limited to, guar gum, sodium alginate, carob, agar, farina-de carob, farina-de guar, xantham gum, carrageenon, and sodium corboxymethylcellose . . . The stabilizer is used to provide solid content and binding capabilities to the composition. It also helps to prevent the alcohol and water from separating as the temperature of the composition is lowered during freezing.” Further, the sugar substitute is required to be one of sucralose and steviol glycosides.

U.S. Pat. No.: 10,813,370 by Isaacs et al. is directed to a system and method for producing stable frozen cocktails and sorbets with high alcohol content. While the method of making this product does not include the use of milk or cream, it does require the addition of a cold-soluble hydrocolloid agent in order to thicken and form gels, and to promote effective retention of the alcoholic beverage in the ice cream, sherbet or sorbet products during and after the freezing process. In fact, this method completely depends on hydrocolloids to trap the alcohol in hydrocolloidal three-dimensional gel structures.

Accordingly, there is a need for a process of making a frozen cream product containing alcohol, where the alcohol containing frozen cream product does not undergo alcohol-water separation during freezing to form the alcohol containing frozen cream product, and the process and final product do not include any additives, preservatives, stabilizers or emulsifiers.

There is also a need for a process of making a frozen cream product containing alcohol, where the alcohol containing frozen cream product does not undergo alcohol-water separation during freezing to form the alcohol, and the process and final frozen cream product includes only natural and organic ingredients.

### SUMMARY OF THE INVENTIVE CONCEPT

The present general inventive concept provides a process of making a frozen cream product containing alcohol, where the frozen cream product containing the alcohol does not undergo alcohol-water separation during the freezing step.

The present general inventive concept provides a frozen cream product containing alcohol, where the frozen cream product containing the alcohol does not undergo alcohol-water separation after being frozen.

The present general inventive concept provides a process of making a frozen cream product containing alcohol which does not include any additives, preservatives, stabilizers or unnatural emulsifiers.

The present general inventive concept provides a frozen cream product containing alcohol which does not include any additives, preservatives, stabilizers or unnatural emulsifiers.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a method of manufacturing a frozen cream product containing alcohol, comprising: whipping a first combined mixture of substantially 13.5% eggs, 4% egg yolks and 6.35% raw agave nectar on a high speed until the combined mixture has at least doubled in volume; heating a second combined mixture of 25.4% whole milk and 25.4% heavy whipping cream to a temperature of at least 190 degrees Fahrenheit; reducing the whipping speed of the first combined mixture of 13.5% eggs, 4% egg yolks and 6.35% agave nectar to a medium speed after the combined mixture has at least tripled in volume and slowly add the heated second combined mixture of 25.4% whole milk and 25.4% heavy whipping cream to combined mixture of 13.5% eggs, 4% egg yolks and 6.35% natural sweetener; reducing the whipping speed of the first combined mixture of 13.5% eggs, 4% egg yolks and 6.35% natural sweetener to a low speed after the heated second combined mixture of 25.4% whole milk and 25.4% heavy whipping cream has been completely added thereto and continue mixing the first and second combined mixtures until the temperature of the first and second combined mixtures reduces to substantially 139 degrees Fahrenheit; adding 25.4% hard alcoholic beverage to the first and second combined mixtures while continuing to whip the first and second combined mixtures at the low speed and continue mixing the first and second combined mixtures and alcohol for one minute; straining the first and second combined mixtures and alcohol; and churning the strained first and second combined mixtures and alcohol in an ice cream forming apparatus until hardened to a desired amount.

In an exemplary embodiment, the agave nectar can be substituted with another natural sweetener, such as maple syrup, honey or sucrose in an amount that will equal the sweetness level provided by the agave nectar.

In an exemplary embodiment, the agave nectar can be substituted with high fructose corn syrup or other substitute sweetener.

In another exemplary embodiment, the alcohol is between 8-10% by volume.

In still another exemplary embodiment, the hard alcohol is between 8-50% by volume.

In still another exemplary embodiment, the eggs, yolks, natural sweetener, whole milk and heavy whipping cream are all organic.

In still another exemplary embodiment, the method further comprises adding a small amount of coffee to the second combined mixtures of whole milk and heavy cream mixture while heating; and adding ¾ cup of chopped chocolate and two chopped up glaze donuts after churning the strained first and second combined mixtures and alcohol in an ice cream forming apparatus to the desired amount, wherein the alcohol is a whisky.

In yet another exemplary embodiment, the method further comprises adding approximately one teaspoon of ground cinnamon to the first and second combined mixtures and alcohol prior to churning the strained first and second combined mixtures and alcohol; and adding a tablespoon of honey after the churning the strained first and second combined mixtures and alcohol; wherein the alcohol is a whiskey.

In yet another exemplary embodiment, the method further comprises scraping the inside of a vanilla bean and adding the scraping to the first combined mixture of 13.5% eggs, 4% egg yolks and 6.35% natural sweetener before adding the second combined mixture of 25.4% whole milk and 25.4% heavy whipping cream; and adding 3 oz of lime juice and zest of two limes to the strained first and second combined mixtures and alcohol; wherein the alcohol is a vodka.

In still another exemplary embodiment, the method further comprises adding a swirl of cranberry to the strained and churned first and second combined mixtures and alcohol.

In yet another exemplary embodiment, the method further comprises adding three cups of banana pudding prior to the churning the strained first and second combined mixtures and alcohol; wherein the alcohol is banana whisky.

In yet another exemplary embodiment, the banana pudding consists of egg yolks, eggs, sugar, cornstarch, milk and banana brandy.

The foregoing and/or other features and utilities of the present general inventive concept may also be achieved by providing a method of manufacturing an organic frozen cream product without the use of any additives and preservatives, comprising: whipping a first combined mixture of substantially 13.5% organic eggs, 4% organic egg yolks and organic 6.35% raw agave nectar on a high speed until the combined mixture has at least doubled in volume; heat a second combined mixture of 25.4% organic whole milk and 25.4% organic heavy whipping cream to a temperature of at least 190 degrees Fahrenheit; reducing the whipping speed of the first combined mixture of the 13.5% organic eggs, organic 4% egg yolks and 6.35% organic agave nectar to a medium speed after the combined mixture has at least doubled in volume and slowly add the heated second combined mixture of the 25.4% organic whole milk and 25.4% organic heavy whipping cream to combined mixture of the 13.5% organic eggs, organic 4% egg yolks and 6.35% organic natural sweetener; reducing the whipping speed of the first combined mixture of the 13.5% organic eggs, organic 4% egg yolks and 6.35% organic natural sweetener to a low speed after the heated second combined mixture of the 25.4% organic whole milk and 25.4% organic heavy whipping cream has been completely added thereto and continue mixing the first and second combined mixtures until the temperature of the first and second combined mixtures reduces to substantially 139 degrees Fahrenheit; straining the first and second combined mixtures; and churning the strained first and second combined mixtures in an ice cream forming apparatus until hardened to a desired amount.

In an exemplary embodiment, the agave nectar can be substituted with another natural sweetener, such as maple syrup, honey or sucrose in an amount that will equal the sweetness level provided by the agave nectar.

In an exemplary embodiment, the agave nectar can be substituted with high fructose corn syrup or other substitute sweetener.

The foregoing and/or other features and utilities of the present general inventive concept may also be achieved by providing a method of manufacturing a frozen cream product containing a high amount of alcohol, comprising: whipping a first combined mixture of 11.7% eggs, 3.5% egg yolks and 5.5% agave nectar or a natural sweetener on a high speed until the combined mixture has at least doubled in volume; heating a second combined mixture of 22.1% whole milk and 22.1% heavy whipping cream to a temperature of at least 190 degrees Fahrenheit; reducing the whipping speed of the first combined mixture of 11.7% eggs, 3.5% egg yolks and 5.5% raw agave nectar to a medium speed after the combined mixture has at least doubled in volume and slowly add the heated second combined mixture of 22.1% whole milk and 22.1% heavy whipping cream to combined mixture of 11.7% eggs, 3.5% egg yolks and 5.5% agave nectar; reducing the whipping speed of the first combined mixture of 11.7% eggs, 3.5% egg yolks and 5.5% agave nectar to a low speed after the heated second combined mixture of 22.1% whole milk and 22.1% heavy whipping cream has been completely added thereto and continue mixing the first and second combined mixtures until the temperature of the first and second combined mixtures reduces to substantially 139 degrees Fahrenheit; adding 35.0% alcoholic beverage at approximately 40% alcohol content to the first and second combined mixtures while continuing to whip the first and second combined mixtures at the low speed and continue mixing the first and second combined mixtures and alcohol for one minute; straining the first and second combined mixtures and alcoholic beverage; and churning the strained first and second combined mixtures and alcoholic beverage in an ice cream forming apparatus until hardened to a desired amount.

In another exemplary embodiment, the percentage of natural sweetener used can be adjusted to result in the equivalent sweetness level provided by the agave nectar.

In another exemplary embodiment, the alcoholic beverage can be between 12-15% by volume.

In another exemplary embodiment, the amount of alcoholic beverage can be 25 fluid oz.

In another exemplary embodiment, the alcoholic beverage can be cinnamon whiskey.

### BRIEF DESCRIPTION OF THE DRAWINGS

These and/or other features and utilities of the present inventive concept will become apparent and more readily appreciated from the following description of the embodiments, taken in conjunction with the accompanying drawing of which:

FIG. 1 illustrates a chart of ingredients, percentages of ingredients proportionally, weight per unit of each ingredient, the weight of each ingredient to make approximately 63 fl. oz of frozen cream product containing alcohol, according to an example embodiment of the present inventive concept.

FIG. 2 illustrates a chart of ingredients, percentages of ingredients proportionally, weight per unit of each ingredient, the weight of each ingredient to make approximately 72 fl. oz of frozen cream product containing 25 fluid ounces of an alcoholic beverage, according to another example embodiment of the present inventive concept.

FIG. 3 illustrates a chart of ingredients, percentages of ingredients proportionally, weight per unit of each ingredient, the weight of each ingredient to make approximately 87 fl. oz of frozen cream product containing 24 fluid ounces of flavoring, according to another example embodiment of the present inventive concept.

### DETAILED DESCRIPTION OF THE PREFERRED EMBODIMENTS

Reference will now be made in detail to the embodiments of the present general inventive concept. The embodiments are described below in order to explain the present general inventive concept while referring to any figures. Also, while describing the present general inventive concept, detailed descriptions about related well-known process steps that may diminish the clarity of the points of the present general inventive concept are omitted.

It will be understood that although the terms “first” and “second” may be used herein to describe various ingredients, these ingredients should not be limited by these terms. These terms are only used to distinguish one ingredient from another ingredient. Thus, a first ingredient could be termed a second ingredient, and similarly, a second ingredient may be termed a first ingredient without departing from the teachings of this disclosure.

Expressions such as “at least one of,” when preceding a list of ingredients, modify the entire list of ingredients and do not modify the individual ingredients of the list.

All terms including descriptive or technical terms which are used herein should be construed as having meanings that are obvious to one of ordinary skill in the art. However, the terms may have different meanings according to an intention of the lexicographer, case precedents, or the appearance of new technologies. Also, some terms may be arbitrarily selected by the applicant, and in this case, the meaning of the selected terms will be described in detail in the detailed description of the invention. Thus, the terms used herein have to be defined based on the meaning of the terms together with the description throughout the specification.

Hereinafter, exemplary embodiments of the present general inventive concept will be described in detail.

The present inventive concept is directed to a process of making a frozen cream product containing alcohol therein, which does not require any additives, preservatives, stabilizers, unnatural emulsifiers, or other unnatural ingredients, and can be limited to only organic ingredients.

The present inventive concept can also be used to making a frozen cream product without containing alcohol, which does not require any additives, preservatives, stabilizers, unnatural emulsifiers, or other unnatural ingredients, and is limited to only organic ingredients.

It has been determined by the inventor through trial and error over a period of several years how to process only natural ingredients in a specific way and in specific separate combinations and specific arrangements, which will result in causing these all natural ingredients to bond together, create a naturally strong emulsifier and stable structure that entraps alcohol, and at the same time provides an environment which prevents alcohol from dissipating and/or evaporating or separating from the frozen cream product during the process and after achieving the finished frozen cream product.

In an example embodiment, portions of each natural ingredient will be provided in volume measured in ounces, and for dry ingredients, numbers and ounces. An important part of the success of this invention is the processes performed on the natural ingredients as well as the separate combination of processes performed and specific arrangement of steps of the processes performed on the ingredients.

Eggs contain proteins that can act as emulsifiers for fat and water that is contained in cream-based product. However, it is the properties of the eggs, the amount of egg yolks vs. egg whites used, and how the specific amount of the components of the eggs are processed which results in creating an emulsifier that can successfully entrap alcohol with a high alcohol content of between 0.5%-15% ABV.

Egg yolks contain high amounts of proteins (over 16%) and must be whipped to act as emulsifiers. This is because egg yolks have some amino acids that repel water (hydrophobic) and some amino acids that attract water (hydrophilic). When whipped, one part of the proteins in an egg yolk sticks to the fat and another part of the proteins in the egg yolk sticks to the water, thus forming a natural binding and stabilizing agent.

Lecithin is another emulsifier found in egg yolks. Lecithin is a fat-like molecule with a hydrophilic “head” and a hydrophobic “tail.” The tail tends to get buried in the fat droplets while the head sticks out of the droplet surface into the surrounding water. This establishes a barrier that prevents the surface of the fat droplet from coming into contact with the surface of another fat droplet.

Egg whites also contain a high amount of proteins (over 10%). Raw egg white proteins are curled up into tight balls, more or less floating in water. Whipping the egg whites makes the protein contained therein “uncurl.” This is due to the fact that egg-white proteins contain both hydrophilic and hydrophobic amino acids. Before whipping, the hydrophobic amino acids are in the center of the protein away from the water and the hydrophilic ones are on the outside closer to the water. When the egg whites are whipped the proteins uncurl and bubbles continue to form. The uncurled proteins bond with each other, thus creating a protein network that can hold the continually forming air bubbles in place.

The following amounts of each ingredient, according to an example embodiment of the present inventive concept, are provided to make a batch of frozen cream product in the amount of substantially 63 fl. oz total volume, and therefore one of ordinary skill in the art will understand that the amount of each of the ingredients can be decreased or increased proportionately in order to make either smaller or larger batches. The percentages of each of the ingredients to manufacture a frozen cream product containing alcohol according to the present inventive concept is substantially 13.5% eggs (fl. oz), 4% egg yolks (fl. oz), 6.35% agave nectar(fl. oz), 25.4% whole milk (fl. oz), 25.4% (approximately 3.25% milk fat) heavy whipping cream (fl. oz) (approximately 36% milk fat) and 25.4% liquor or other hard alcoholic beverage (fl. oz). However, one of ordinary skill in the art will understand that small adjustments made to the above-listed percentages of each of the listed ingredients and small adjustments to the plurality of processes described below, which still result in the intended purposes described herein (i.e., creating specific combined mixtures and processing the combined mixtures according to specific defined steps) of entrapping alcohol and preventing the alcohol from evaporating and/or dissipating from the processes being performed, during the process of freezing the combined mixtures, and after the combined mixtures and alcohol are made into a frozen cream product containing alcohol, are within equivalent percentages of ingredients and equivalent processes, and therefore will not depart from the principles and spirit of the present general inventive concept as described herein.

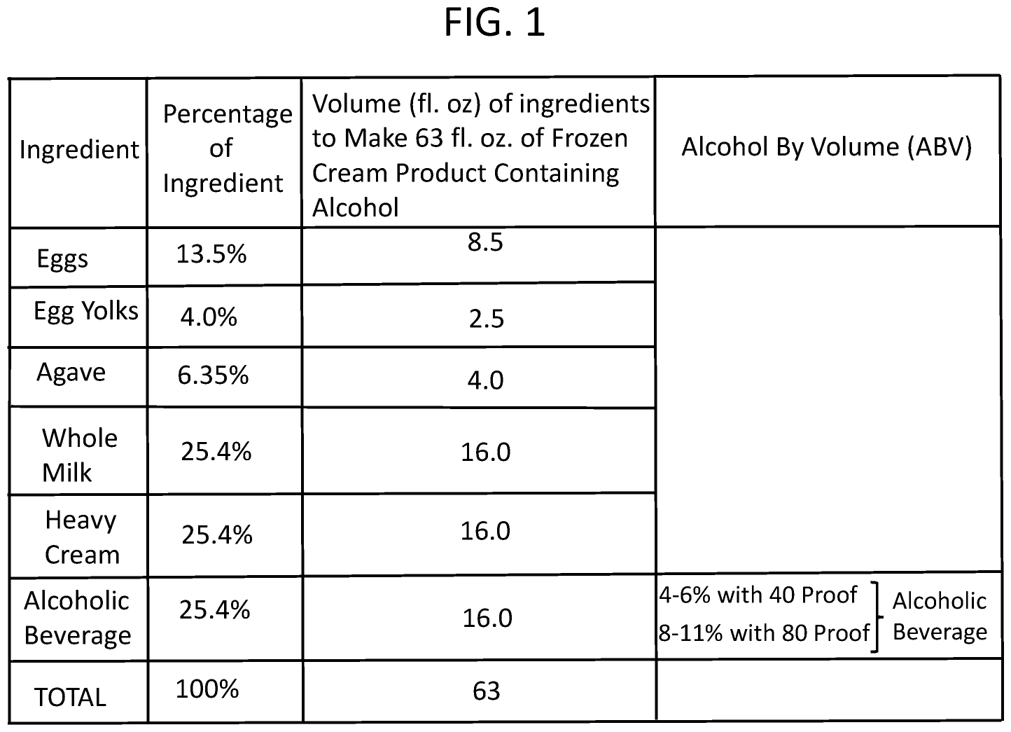

FIG. 1 illustrates a chart of the ingredients, percentages of the ingredients and the weight in volume of each ingredient used to manufacture a frozen cream product containing a hard alcoholic beverage ranging between 1-15% alcohol by volume (ABV), being between 40-80 proof, according to this example embodiment of the present inventive concept. It is to be noted that small adjustments can be made to each of the ingredients illustrated in FIG. 1, which will result in the intended purposes of the present inventive concept, as described herein, without departing from the spirit and scope of the present inventive concept.

A description of a plurality of ingredients, specifically combined mixtures and specifically listed processes in specific orders, to manufacture a frozen cream product containing alcohol according to the present inventive concept, will now be described.

The following ingredients are provided in portions which make substantially 63 oz of a final total amount of ingredients. It is to be noted that as a result of the different processes, the total amount of the final frozen cream product containing alcohol can increase by between approximately 0-3% in volume.

First, place substantially 8.5 fl. oz of eggs (approximately 5 large eggs, preferably organic), substantially 2.5 fl. oz of egg yolks (approximately 4 egg yolks; preferably organic) and substantially 4.0 fl. oz of agave nectar (a nectar from a cactus plant) into a mixing bowl (i.e., a mixing bowl of a Kitchen Aid® mixer or similar mixing apparatus). It is to be noted that the agave nectar can be substituted with a natural sweetener, such maple syrup, honey or sucrose, at which point the amount of sweetener may need to be adjusted to provide the same sweetening result as the raw agave nectar. It is to be noted that high fructose corn syrup or other sweeteners can be used instead of agave nectar or a natural sweetener, and while not being either natural or organic, can provide the resulting frozen cream product containing alcohol, and therefore these alternative sweeteners can be used as an equivalent sweetener without departing from the spirit and scope of the overall present inventive concept.

Whip the eggs, egg yolks and agave (or other natural sweetener) mixture on high speed with a whisk attachment until the mixture has at least doubled in size, and preferably triple or quadruple in size when obtainable. As pointed out above, the proteins will uncurl and the bubbles that continue to form will be held in place by the protein network. While the combined egg and agave mixture is whipping, mix 16 oz of whole milk (preferably organic) and 16 oz of heavy cream (preferably organic) together in a separate bowl and heat the milk and heavy cream mixture to a temperature of at least 190 degrees Fahrenheit (F) (aka: 87.78 degrees Celsius (C)). Heavy cream and whole milk will give the resulting frozen cream product a smooth and light consistency. The high fat content in heavy whipping cream will coat existing ice crystals, thus preventing these ice crystals from enlarging. The high fat content of the whipping cream also acts as a lubricant between the ice crystals, making the frozen cream product with ice crystals taste smooth. Further, heavy whipping cream is also excellent at trapping and holding air when the mixture is stirred and frozen, which gives the frozen cream product more body.

Once the combined egg and agave mixture has at least doubled in size (triple or quadruple in size is preferable when obtainable) and the whole milk and heavy cream mixture has reached 190 degrees F., reduce the whipping speed of the egg and agave mixture to medium and slowly add the combined whole milk and heavy cream mixture to the whipping egg and agave mixture. When the combined hot heavy cream and whole milk mixture is whipped into the egg/agave mixture, the combined network of interconnected proteins is further strengthened by the addition of the heated fat and additional protein molecules. When the captured air bubbles are heated, they expand as the air inside them heats up. The protein network surrounding bubbles solidifies in the heat, and the structure doesn't collapse when the bubbles burst.

Once the full amount of heated whole milk and heavy cream mixture has been added to the whipping egg and agave mixture, reduce the speed of the whipping to low and continue whipping until the temperature of the combined egg/agave mixture and whole milk/heavy cream mixture has reduced to substantially 139 degrees F. It is to be noted that 139 degrees F. is the best temperature to add the alcoholic beverage so that the added alcohol within the alcoholic beverage will not evaporate.

With the mixture still whipping, add 16 fl. oz (approximately 6.4 fluid oz pure alcohol) of 80 proof (40% alcohol) alcohol to the warm mixture, which will equate to substantially 10% ABV. It is to be noted that 6.4 fluid oz pure alcohol was obtained from the following calculation: 16 fl. oz of the 40% alcohol based liquid drink is multiplied by 40% alcohol, which equates to 6.4 fl. oz pure alcohol. For a total amount of combined ingredients being 63 fl. oz, the amount of alcohol by volume is determined by dividing 6.4 fl. oz by 63 fl. oz, which equates to substantially 10 ABV of alcohol in the mixed product. Continue mixing the combined egg/agave mixture, the whole milk/heavy cream mixture and the alcohol for another minute and then stop the whipping and strain the entire mixture.

Once the entire mixture of combined egg/agave mixture and whole milk/heavy cream and alcohol has been strained churn the strained mixture in a batch ice cream machine or hand operated ice cream making apparatus. Note, it is not necessary to cool the mixture before churning. Continue to churn the mixture until the mixture becomes hardened to a desired frozen consistency and then pack the hardened mixture into carton and store at 0 degrees F. If desired, add-ins can be included in the churned mixture. When including add-ins, churn the mixture to a point where the mixture becomes hardened, yet still soft enough to be able to stir into the frozen mixture add-ins, such as chocolate, fruit, nuts, chopped up donuts, etc.

After the churning process is completed, and after including the add-ins if desired, the completed frozen cream product containing alcohol can be packed into a carton or other storage device and stored at approximately 0 degrees F. The churning process may introduce additional air bubbles into the mixture, which may introduce more volume to the mixture, although determined by experimentation to be negligible. The churning also scrapes the sides of the bowl/tube of the ice cream machine, clearing ice crystals that have formed. As a result, any remaining ice crystals, along with the alcohol, are trapped in the network of interconnected proteins. The final resulting frozen cream product containing alcohol will have formed a strong emulsion with strong protein bonding, which provides a structure to entrap alcohol without compromising the flavor or texture of the final frozen cream product containing alcohol.

It is to be noted that as a result of the amount of eggs and egg yolks used, the amount and speeds used during the whipping of the eggs and egg yolks, the amount and speeds used during the whipping of the combination of eggs, egg yolks, natural sweetener, whole milk and heavy cream, and the specific temperatures used during the various processes, as described above, the alcohol contained in the combined mixtures become entrapped therein and will not evaporate or dissipate. Furthermore, as a result of the amount of eggs and egg yolks used, the amount and speeds used during the whipping of the eggs and egg yolks, the amount and speeds used during the whipping of the combination of eggs, egg yolks, natural sweetener, whole milk and heavy cream, and the specific temperatures used during the various processes, as described above, the combined mixtures containing the alcohol will not undergo alcohol-water separation during the processes of churning or freezing thereof to form the frozen cream product containing alcohol.

It is also to be noted that tests over several years have included the addition of alcohol in a range of between substantially 0-14% ABV into the mixture of ingredients and processes according to the example embodiments described herein, and the results have been successful in that no alcohol has dissipated or evaporated during the process of making the frozen cream product containing alcohol and during the freezing process of the finished product. Moreover, the finished product with up to 14% ABV has withstood sitting in a cool environment (34-41 degrees F.) without freezing for up to six months with no separation, not thickening, no bubbling and no scent except for the scent of alcohol and any flavorings added.

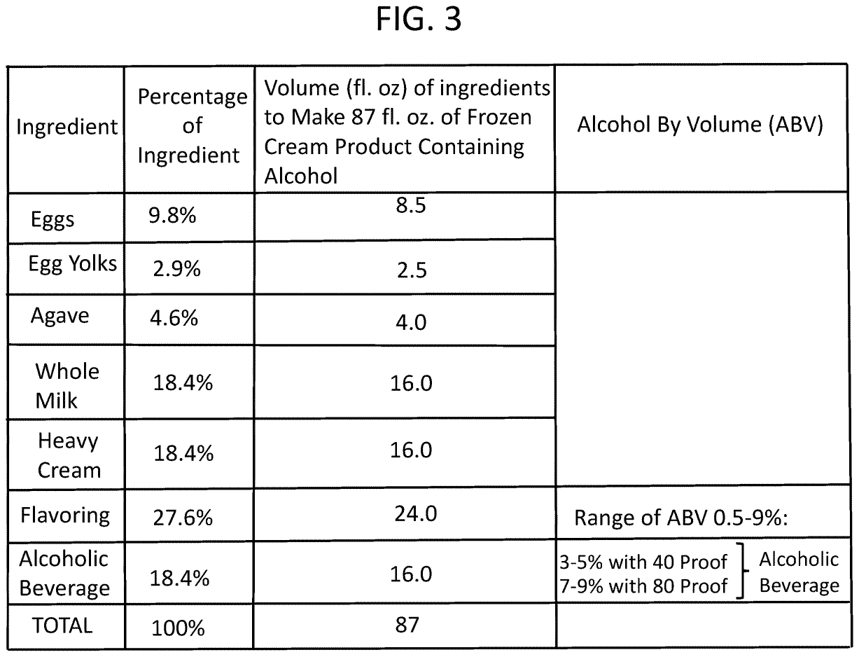

The above-described amounts of ingredients for making the frozen cream product containing alcohol have been provided to make a total weight of ingredients substantially 63 oz. However, one of ordinary skill in the art will appreciate that a smaller amount or a larger amount of the frozen cream product containing alcohol can be made by decreasing or increasing the amount of each of the ingredients proportionally, by following the percentage of ingredients column provided in FIG. 1. Further, one of ordinary skill in the art will appreciate that the final volume of ingredients of the finished product may be larger than 63 fl. oz when flavorings and/or add-ins are added, which is described in more detail below and in the embodiment described with reference to FIG. 3.

According to the frozen cream product as described above, the percentage of fat from the milk/heavy cream is substantially 10%, the percentage of non-fat milk solids (MSNF) is substantially 3.7%, and the percentage of egg yolk is substantially 9.1%. It is to be noted that according to the Code of Federal Regulations Title 21, Part 135: (https://www.ecfr.gov/current/title-21/chapter-I/subchapter-B/part-135 #135.3), the frozen cream product disclosed herein is different from an ice cream per se or a frozen custard per se, since ice cream must contain at least 10% milk fat, not less than 10% non-fat milk solids (MSNF) and less than 1.4% egg yolk, and frozen custard must contain at least 10% milk fat, not less than 10% non-fat milk solids (MSNF) and more than 1.4% egg yolk.

The above-described processes of making the frozen cream product containing alcohol according to the present embodiment has not included the optional addition of flavorings/add-ins and/or the addition of a specific type of alcohol(s) being used. Some of the example add-ins and alcohols that can be used in the above describe processes, according to example embodiments of the present inventive concept, are provided below. It is to be noted that these example embodiments of flavorings and types of alcohol that can be added are not limiting in scope, and variations thereof can be made without departing from the principles and spirit of the general inventive concept described herein.

A coffee and donut whisky flavored frozen cream product can be made by using a coffee whisky. Here, coffee can be added to the whole milk/heavy cream mixture while this mixture is being heated. Chopped chocolate in an amount of substantially ¾ cup (12 oz) and two broken up glazed donuts can be added after churning the whipped combination of eggs, agave, whole milk and heavy cream.

A cinnamon whisky flavored frozen cream product can be made by using whisky as the alcoholic beverage. Then approximately three shakes of cinnamon can be added to the whipped combination of eggs, agave, whole milk and heavy cream prior to churning.

A roasted banana pudding whisky flavored frozen cream product can be made by using banana whisky. Then three cups of banana pudding can be added to the whipped combination of eggs, agave, whole milk and heavy cream prior to churning.

A vanilla gimlet flavored frozen cream product can be made by using vodka as the alcohol. Here vanilla from vanilla beans is added to the eggs/agave mixture and then 3 oz of Roses Lime Juice® and the zest of two limes can be added to the eggs/agave mixture. After churning the whipped combination of eggs, agave, whole milk and heavy cream a cranberry swirl may be added.

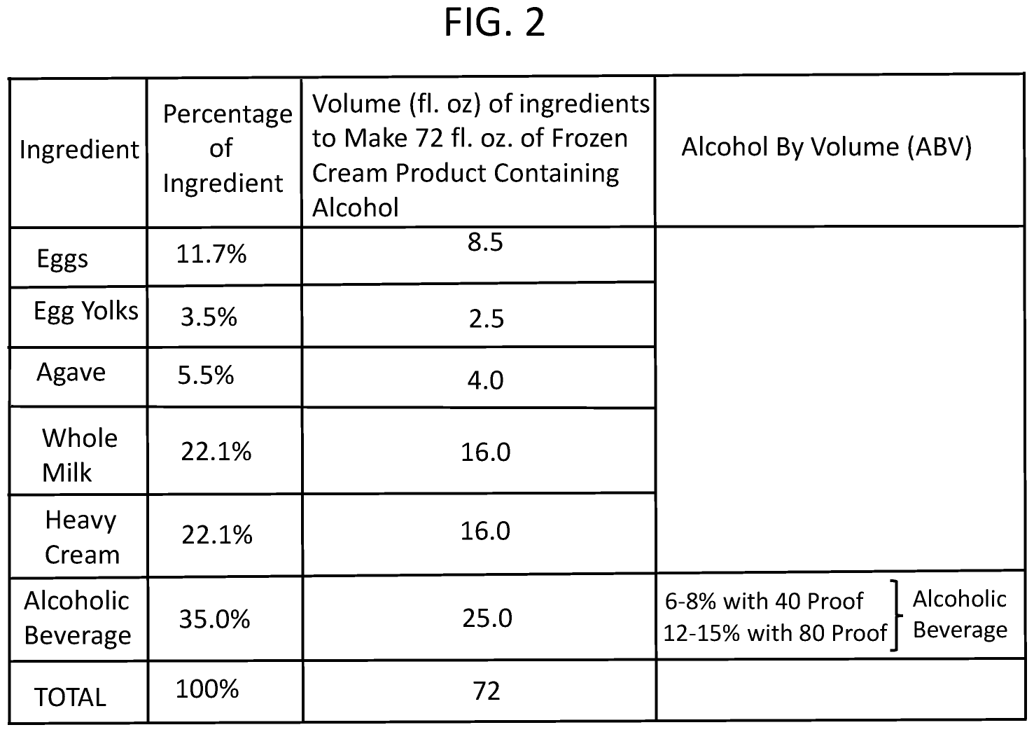

FIG. 2 illustrates a chart of ingredients, percentages of the ingredients and the weight in volume of each ingredient used to manufacture a frozen cream product containing a larger amount of alcoholic beverage, in accordance with another example embodiment of the present inventive concept. In accordance with the example embodiment as illustrated in FIG. 2, the amounts of each ingredient listed below are provided to make a batch of frozen cream product in the amount of substantially 72 fl. oz total volume, wherein the amount of alcoholic beverage is increased to 35.0%, equaling a total of 25.0 fl. oz thereof. In this example embodiment, the percentages of each of the ingredients used to manufacture a frozen cream product containing alcohol is substantially 11.7% eggs, 3.5% egg yolks, 5.5% agave nectar, 22.1% whole milk, 22.1% (approximately 3.25% milk fat) heavy whipping cream (approximately 36% milk fat) and 35% liquor or other hard alcoholic beverage. Here the frozen cream product contains a hard alcoholic beverage ranging between 6-15% alcohol by volume (ABV) (when the alcohol is between 40-80 proof). It is to be noted that small adjustments can be made to each of the ingredients illustrated in FIG. 2, which result in the intended purposes of the present inventive concept as described herein, without departing from the spirit and scope of the present inventive concept.

The following list of ingredients are provided in portions (fluid oz) which make substantially 72 fl. oz of a total amount of ingredients. It is to be noted that as a result of the different processes, the total amount of the final frozen cream product containing alcohol can increase by between 0-3% in volume.

First, place substantially 8.5 fl. oz of eggs (preferably organic), substantially 2.5 fl. oz of egg yolks (preferably organic) and substantially 4.0 fl. oz of agave nectar into a mixing bowl. It is to be noted that the agave nectar can be substituted with a natural sweetener, such as maple syrup, honey or sucrose, in which different portions thereof may be required to provide a sufficient sweetening result as provided by the raw agave nectar. As pointed out above, high fructose corn syrup or other sweeteners can be used instead of agave nectar or a natural sweetener, and while not being either natural or organic, can provide an equivalent frozen cream product containing alcohol, and therefore can be used as an equivalent sweetener.

Whip the eggs, egg yolks and agave (or other natural sweetener) mixture on high speed with a whisk attachment until the mixture has at least doubled in size, and preferably triple or quadruple in size when obtainable. As pointed out above, the proteins will uncurl and the bubbles that continue to form will be held in place by the protein network. While the combined egg and agave mixture is whipping, mix 16 oz of whole milk (preferably organic) and 16 oz of heavy cream (preferably organic) together in a separate bowl and heat the milk and heavy cream mixture to a temperature of at least 190 degrees F. (87.78 degrees Celsius (C)). Heavy cream and whole milk will give the resulting frozen cream product a smooth and light consistency. The high fat content in heavy whipping cream will coat existing ice crystals, thus preventing these ice crystals from enlarging. The high fat content of the whipping cream also acts as a lubricant between the ice crystals, making the frozen cream product with ice crystals taste smooth. Further, heavy whipping cream is also excellent at trapping and holding air when the mixture is stirred and frozen, which gives the frozen cream product more body.

Once the combined egg and agave mixture has at least doubled in size (triple or even quadruple in size is preferable when obtainable) and the whole milk and heavy cream mixture has reached 190 degrees F., reduce the whipping speed of the egg and agave mixture to medium and slowly add the combined whole milk and heavy cream mixture to the whipping egg and agave mixture. When the combined hot heavy cream and whole milk mixture is whipped into the egg/agave mixture, the combined network of interconnected proteins is further strengthened by the addition of the heated fat and additional protein molecules. When the captured air bubbles are heated, they expand as the air inside them heats up. The protein network surrounding bubbles solidifies in the heat, and the structure doesn't collapse when the bubbles burst.

Once the full amount of heated whole milk and heavy cream mixture has been added to the whipping egg and agave mixture, reduce the speed of the whipping to low and continue whipping until the temperature of the combined egg/agave mixture and whole milk/heavy cream mixture has reduced to substantially 139 degrees F. It is to be noted that 139 degrees F. is the best temperature to add alcohol so that the added alcohol will not evaporate.

With the mixture still whipping, add 25 fl. oz (approximately 10 fluid oz pure alcohol) of 80 proof alcohol (40% alcohol) to the warm mixture, which will equate to substantially 12-15% ABV. It is to be noted that 10 fluid oz of pure alcohol was obtained from the following calculation: 25 fl. oz of the 40% alcohol based liquid drink is multiplied by 40% alcohol, which equates to 10 fl. oz of pure alcohol. For a total amount of combined ingredients being 72 fl. oz, the amount of alcohol by volume is determined by dividing 10 fl. oz by 72 fl. oz, which equates to substantially 13.9% ABV in the mixed product. Continue mixing the combined egg/agave mixture, the whole milk/heavy cream mixture and the alcohol for another minute and then stop the whipping and strain the entire mixture.

Once the entire mixture of combined egg/agave mixture and whole milk/heavy cream and alcohol has been strained churn the strained mixture in a batch ice cream machine or hand operated ice cream making apparatus. Note, it is not necessary to cool the mixture before churning. Continue to churn the mixture until the mixture becomes hardened to a desired frozen consistency and then pack the hardened mixture into carton and store at 0 degrees F. If desired, add-ins can be included in the churned mixture. When including add-ins, churn the mixture to a point where the mixture becomes hardened, yet still soft enough to be able to stir into the frozen mixture add-ins, such as chocolate, fruit, nuts, chopped up donuts, etc.

After the churning process is completed, and after including the add-ins if desired, the completed frozen cream product containing alcohol can be packed into a carton or other storage device and stored at approximately 0 degrees F. The churning process may introduce additional air bubbles into the mixture, which may introduce more volume to the mixture, although determined by experimentation to be negligible. The churning also scrapes the sides of the bowl/tube of the ice cream machine, clearing ice crystals that have formed. As a result, any remaining ice crystals, along with the alcohol, are trapped in the network of interconnected proteins. The final resulting frozen cream product containing alcohol will have formed a strong emulsion with strong protein bonding, which provides a structure to entrap alcohol without compromising the flavor or texture of the final frozen cream product containing alcohol.

It is to be noted that as a result of the amount of eggs and egg yolks used, the amount and speeds used during the whipping of the eggs and egg yolks, the amount and speeds used during the whipping of the combination of eggs, egg yolks, natural sweetener, whole milk and heavy cream, and the specific temperatures used during the various processes, as described above, the alcohol contained in the combined mixtures become entrapped therein and will not evaporate or dissipate. Furthermore, as a result of the amount of eggs and egg yolks used, the amount and speeds used during the whipping of the eggs and egg yolks, the amount and speeds used during the whipping of the combination of eggs, egg yolks, natural sweetener, whole milk and heavy cream, and the specific temperatures used during the various processes, as described above, the combined mixtures containing the alcohol will not undergo alcohol-water separation during the processes of churning or freezing thereof to form the frozen cream product containing alcohol.

It is also to be noted that tests over several years have included the addition of alcohol in a range of between substantially 0-14% ABV into the mixture of ingredients and processes according to the example embodiments described herein, and the results have been successful in that no alcohol has dissipated or evaporated during the process of making the frozen cream product containing alcohol and during the freezing process of the finished product. Moreover, the finished product with up to 14% ABV has withstood sitting in a cool environment (34-41 degrees F.) without freezing for up to six months with no separation, not thickening, no bubbling and no scent except for the scent of alcohol and any flavorings added.

An example embodiment of a frozen cream product with 25 fl. oz of alcoholic beverage is a Cinnamon Whiskey frozen cream product, which uses an 80 proof Cinnamon Whiskey, resulting in a frozen cream product having substantially 14% ABV.

FIG. 3 illustrates a chart of ingredients, percentages of the ingredients and the weight in volume of each ingredient used to manufacture a frozen cream product containing 16.0 fluid oz or alcoholic beverage as well as substantially 24 fluid oz of flavoring, in accordance with still another example embodiment of the present inventive concept. In accordance with the example embodiment as illustrated in FIG. 3, the amounts of each ingredient listed below are provided to make a batch of frozen cream product in the amount of substantially 87 fl. oz total volume, wherein the amount of alcoholic beverage is 18.4% thereof. In this example embodiment, the percentages of each of the ingredients to manufacture a frozen cream product containing alcohol according to the present inventive concept is substantially 9.8% eggs, 2.9% egg yolks, 4.6% agave nectar, 18.4% whole milk, 18.4% (approximately 3.25% milk fat) heavy whipping cream (approximately 36% milk fat), 27.6% of a flavoring, and 18.4% liquor or other hard alcoholic beverage. Here the frozen cream product contains a hard alcoholic beverage ranging between 7-9% alcohol by volume (ABV) (having 80 proof alcoholic beverage). It is to be noted that small adjustments can be made to each of the ingredients illustrated in FIG. 3, which will result in the intended purposes of the present inventive concept, as described herein, without departing from the spirit and scope of the present inventive concept.

The following ingredients are provided in portions which make substantially 87 fl. oz of a final total amount of ingredients. It is to be noted that as a result of the different processes, the total amount of the final frozen cream product containing alcohol can increase by between 0-3% in volume. First, place substantially 8.5 fl. oz of eggs (preferably organic), substantially 2.5 fl. oz of egg yolks (preferably organic) and substantially 4.0 fl. oz of agave nectar into a mixing bowl. Whip the eggs, egg yolks and agave (or other natural sweetener) mixture on high speed with a whisk attachment until the mixture has at least doubled in size, and preferably triple in size when obtainable. As pointed out above, the proteins will uncurl and the bubbles that continue to form will be held in place by the protein network. While the combined egg and agave mixture is whipping, mix 18.4 fl. oz of whole milk (preferably organic), 18.4 fl. oz of heavy cream (preferably organic) and 24.0 fl. oz of flavoring to a separate bowl and heat the milk, heavy cream and flavoring mixture to a temperature of at least 190 degrees F. (87.78 degrees Celsius (C)). Heavy cream and whole milk will give the resulting frozen cream product a smooth and light consistency. The high fat content in heavy whipping cream will coat existing ice crystals, thus preventing these ice crystals from enlarging. The high fat content of the whipping cream also acts as a lubricant between the ice crystals, making the frozen cream product with ice crystals taste smooth. Further, heavy whipping cream is also excellent at trapping and holding air when the mixture is stirred and frozen, which gives the frozen cream product more body.

Once the combined egg and agave mixture has at least doubled in size (triple or even quadruple in size is preferable when obtainable) and the whole milk, heavy cream and flavoring mixture has reached 190 degrees F., reduce the whipping speed of the egg and agave mixture to medium and slowly add the combined whole milk, heavy cream and flavoring mixture to the whipping egg and agave mixture. When the combined hot whole milk, heavy cream and flavoring mixture is whipped into the egg/agave mixture, the combined network of interconnected proteins is further strengthened by the addition of the heated fat and additional protein molecules. When the captured air bubbles are heated, they expand as the air inside them heats up. The protein network surrounding bubbles solidifies in the heat, and the structure doesn't collapse when the bubbles burst.

Once the full amount of heated whole milk, heavy cream and flavoring mixture has been added to the whipping egg and agave mixture, reduce the speed of the whipping to low and continue whipping until the temperature of the combined egg/agave mixture and whole milk, heavy cream and flavoring mixture has reduced to substantially 139 degrees F. As pointed out above, 139 degrees F. is the best temperature to add alcohol so that the added alcohol will not evaporate.

With the mixture still whipping, add 16 fl. oz (approximately 6.4 fluid oz pure alcohol) of 80 proof alcohol (40% alcohol) to the warm mixture, which will equate to substantially 7-9% ABV. It is to be noted that 6.4 fluid oz pure alcohol was obtained from the following calculation: 16 fl. oz of the 40% alcohol based liquid drink is multiplied by 40% alcohol, which equates to 6.4 fl. oz pure alcohol. For a total amount of combined ingredients being 87 fl. oz, the amount of alcohol by volume is determined by dividing 6.4 fl. oz by 87 fl. oz, which equates to substantially 7.3 ABV of alcohol in the mixed product. Continue mixing the combined egg/agave mixture, the whole milk, heavy cream and flavoring mixture and the alcohol for another minute and then stop the whipping and strain the entire mixture.

Once the entire mixture of combined egg/agave mixture and whole milk, heavy cream, flavoring and alcohol has been strained churn the strained mixture in a batch ice cream machine or hand operated ice cream making apparatus. Note, it is not necessary to cool the mixture before churning. Continue to churn the mixture until the mixture becomes hardened to a desired frozen consistency and then pack the hardened mixture into a carton and store at 0 degrees F. If desired, add-ins can be included in the churned mixture. When including add-ins, churn the mixture to a point where the mixture becomes hardened, yet still soft enough to be able to stir into the frozen mixture add-ins, such as chocolate, fruit, nuts, chopped up donuts, etc.

After the churning process is completed, and after including the add-ins if desired, the completed frozen cream product containing alcohol can be packed into a carton or other storage device and stored at approximately 0 degrees F. The churning process may introduce additional air bubbles into the mixture, which may introduce more volume to the mixture, although determined by experimentation to be negligible. The churning also scrapes the sides of the bowl/tube of the ice cream machine, clearing ice crystals that have formed. As a result, any remaining ice crystals, along with the alcohol, are trapped in the network of interconnected proteins. The final resulting frozen cream product containing alcohol will have formed a strong emulsion with strong protein bonding, which provides a structure to entrap alcohol without compromising the flavor or texture of the final frozen cream product containing alcohol.

It is to be noted that as a result of the amount of eggs and egg yolks used, the amount and speeds used during the whipping of the eggs and egg yolks, the amount and speeds used during the whipping of the combination of eggs, egg yolks, natural sweetener, whole milk, heavy cream and flavoring, and the specific temperatures used during the various processes, as described above, the alcohol contained in the combined mixtures become entrapped therein and will not evaporate or dissipate. Furthermore, as a result of the amount of eggs and egg yolks used, the amount and speeds used during the whipping of the eggs and egg yolks, the amount and speeds used during the whipping of the combination of eggs, egg yolks, natural sweetener, whole milk, heavy cream and flavoring, and the specific temperatures used during the various processes, as described above, the combined mixtures containing the alcohol will not undergo alcohol-water separation during the processes of churning or freezing thereof to form the frozen cream product containing alcohol.

It is also to be noted that tests over several years have included the addition of alcohol in a range of between substantially 1-14% ABV into the mixture of ingredients and processes according to the example embodiments described herein, and the results have been successful in that no alcohol has dissipated or evaporated during the process of making the frozen cream product containing alcohol and during the freezing process of the finished product. Moreover, the finished product with up to substantially 14% ABV has withstood sitting in a cool environment (34-41 degrees F.) without freezing for up to six months with no separation, not thickening, no bubbling and no scent except for the scent of alcohol and any flavorings added.

An example embodiment of a frozen cream product with a mix of 80 proof alcohol and flavoring to amount in a total of 25 fl. oz (i.e., 16 fl. oz of 80 proof alcoholic beverage and 9 fl. oz of flavoring) is a Rum & Coke frozen cream product containing alcohol.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of manufacturing a frozen cream product containing alcohol, comprising:
whipping a first combined mixture of 13.5% eggs, 4% egg yolks and 6.35% agave nectar or a natural sweetener on a high speed until the combined mixture has at least doubled in volume;
heating a second combined mixture of 25.4% whole milk and 25.4% heavy whipping cream to a temperature of at least 190 degrees Fahrenheit;
reducing the whipping speed of the first combined mixture of 13.5% eggs, 4% egg yolks and 6.35% agave nectar to a medium speed after the combined mixture has at least doubled in volume and slowly add the heated second combined mixture of 25.4% whole milk and 25.4% heavy whipping cream to combined mixture of 13.5% eggs, 4% egg yolks and 6.35% agave nectar;
reducing the whipping speed of the first combined mixture of 13.5% eggs, 4% egg yolks and 6.35% agave nectar to a low speed after the heated second combined mixture of 25.4% whole milk and 25.4% heavy whipping cream has been completely added thereto and continue mixing the first and second combined mixtures until the temperature of the first and second combined mixtures reduces to substantially 139 degrees Fahrenheit;
adding 25.4% alcoholic beverage at approximately 40% alcohol content to the first and second combined mixtures while continuing to whip the first and second combined mixtures at the low speed and continue mixing the first and second combined mixtures and alcohol for one minute;
straining the first and second combined mixtures and alcoholic beverage; and
churning the strained first and second combined mixtures and alcoholic beverage in an ice cream forming apparatus until hardened to a desired amount.

2. The method according to claim 1, wherein the natural sweetener is maple syrup, honey or sucrose in an amount that equals a sweetness level provided by the agave nectar.

3. The method according to claim 1, wherein the alcohol is between 8-11% by volume.

4. The method according to claim 1, wherein the alcohol is between 8-13% by volume.

5. The method of claim 1, wherein the eggs, yolks, natural sweetener, whole milk and heavy whipping cream are all organic.

6. The method according to claim 1, further comprising:
adding a small amount of coffee to the second combined mixtures of whole milk and heavy cream mixture while heating; and
adding ¾ cup of chopped chocolate and two chopped up glaze donuts after churning the strained first and second combined mixtures and alcohol in an ice cream forming apparatus to the desired amount,
wherein the alcohol is a whiskey.

7. The method according to claim 1, further comprising:
adding approximately one teaspoon of ground cinnamon to the first and second combined mixtures and alcohol prior to churning the strained first and second combined mixtures and alcohol; and
adding a tablespoon of honey after the churning the strained first and second combined mixtures and alcohol;
wherein the alcohol is a whiskey.

8. The method according to claim 1, further comprising:
scraping the inside of a vanilla bean and adding the scraping to the first combined mixture of 13.5% eggs, 4% egg yolks and 6.35% agave nectar before adding the second combined mixture of 25.4% whole milk and 25.4% heavy whipping cream; and
adding 3 oz of lime juice and zest of two limes to the strained first and second combined mixtures and alcohol;
wherein the alcohol is a vodka.

9. The method according to claim 8, further comprising:
adding a swirl of cranberry to the strained and churned first and second combined mixtures and alcohol.

10. The method according to claim 1, further comprising:
adding three cups of banana pudding prior to the churning the strained first and second combined mixtures and alcohol;
wherein the alcohol is banana whiskey.

11. The method according to claim 10, wherein the banana pudding consists of egg yolks, eggs, sugar, cornstarch, milk and banana brandy.

12. A method of manufacturing an organic frozen cream product without the use of any additives and preservatives, comprising:
whipping a first combined mixture of 13.5% organic eggs, 4% organic egg yolks and organic 6.35% agave nectar on a high speed until the combined mixture has at least tripled in volume;
heating a second combined mixture of 25.4% organic whole milk and 25.4% organic heavy whipping cream to a temperature of at least 190 degrees Fahrenheit;
reducing the whipping speed of the first combined mixture of the 13.5% organic eggs, organic 4% egg yolks and 6.35% agave nectar to a medium speed after the combined mixture has at least doubled in volume and slowly add the heated second combined mixture of the 25.4% organic whole milk and 25.4% organic heavy whipping cream to combined mixture of the 13.5% organic eggs, organic 4% egg yolks and 6.35% agave nectar;
reducing the whipping speed of the first combined mixture of the 13.5% organic eggs, organic 4% egg yolks and 6.35% agave nectar or natural sweetener to a low speed after the heated second combined mixture of the 25.4% organic whole milk and 25.4% organic heavy whipping cream has been completely added thereto and continue mixing the first and second combined mixtures until the temperature of the first and second combined mixtures reduces to substantially 139 degrees Fahrenheit;
adding 25.4% non-alcoholic beverage flavoring to the first and second combined mixtures while continuing to whip the first and second combined mixtures at the low speed and continue mixing the first and second combined mixtures and alcohol for one minute;
straining the first and second combined mixtures and the non-alcoholic beverage flavoring; and
churning the strained first and second combined mixtures and the non-alcoholic beverage flavoring in an ice cream forming apparatus until hardened to a desired amount.

13. The method according to claim 12, wherein the natural sweetener is syrup, honey or sucrose in an amount that equals a sweetness level provided by the agave nectar.

14. A method of manufacturing a frozen cream product containing a high amount of alcohol, comprising:
whipping a first combined mixture of 11.7% eggs, 3.5% egg yolks and 5.5% agave nectar or a natural sweetener on a high speed until the combined mixture has at least doubled in volume;
heating a second combined mixture of 22.1% whole milk and 22.1% heavy whipping cream to a temperature of at least 190 degrees Fahrenheit;
reducing the whipping speed of the first combined mixture of 11.7% eggs, 3.5% egg yolks and 5.5% agave nectar to a medium speed after the combined mixture has at least doubled in volume and slowly add the heated second combined mixture of 22.1% whole milk and 22.1% heavy whipping cream to combined mixture of 11.7% eggs, 3.5% egg yolks and 5.5% agave nectar;
reducing the whipping speed of the first combined mixture of 11.7% eggs, 3.5% egg yolks and 5.5% agave nectar to a low speed after the heated second combined mixture of 22.1% whole milk and 22.1% heavy whipping cream has been completely added thereto and continue mixing the first and second combined mixtures until the temperature of the first and second combined mixtures reduces to substantially 139 degrees Fahrenheit;
adding 35.0% alcoholic beverage at approximately 40% alcohol content to the first and second combined mixtures while continuing to whip the first and second combined mixtures at the low speed and continue mixing the first and second combined mixtures and alcohol for one minute;
straining the first and second combined mixtures and alcoholic beverage; and
churning the strained first and second combined mixtures and alcoholic beverage in an ice cream forming apparatus until hardened to a desired amount.

15. The method according to claim 14, wherein when using the natural sweetener the percentage thereof is adjusted by an amount to provide the equivalent sweetness level as the agave nectar.

16. The method according to claim 14, wherein the alcoholic beverage is between 12-15% by volume.

17. The method according to claim 14, wherein the amount of alcoholic beverage is 25 fluid oz.

18. The method according to claim 17, wherein the alcoholic beverage is cinnamon whiskey.
